(19) United States
(12) Patent Application Publication
(10) Pub. No.: US 2025/0307480 A1
(43) Pub. Date: Oct. 2, 2025

(54) SYSTEM AND METHOD FOR PROVIDING INTERACTIVE USER EXPERIENCE IN VIRTUAL INDUSTRY PREMISES

(71) Applicant: HCL Technologies Limited, New Delhi (IN)

(72) Inventors: Ramprasath Venugopal, Bangalore (IN); Sathish Anand Sadhanandan, Chennai (IN); Harshit Gaur, Noida (IN); Divyansh Singh, Noida (IN)

(21) Appl. No.: 19/074,522

(22) Filed: Mar. 10, 2025

(30) Foreign Application Priority Data
Mar. 30, 2024 (IN) 202411026500

(51) Int. Cl. G06F 30/12; G06F 21/31

(52) U.S. Cl. CPC G06F 30/12; G06F 21/31

(57) ABSTRACT

This disclosure relates to a method and system for providing an interactive user experience in a virtual industry premises. The method includes receiving information associated with a plurality of physical assets within a physical industry premises; and creating the virtual industry premises corresponding to the physical industry premises based on the information, using a digital twin technology and an Artificial Intelligence (AI) model. The virtual industry premises includes a plurality of Three-Dimensional (3D) virtual replicas of the plurality of physical assets. The method includes dynamically receiving data corresponding to the plurality of physical assets and updating the virtual industry premises based on the data. The method includes initiating a user experience in the virtual industry premises based on a user role, upon a successful verification of user credentials received from the user.

### TECHNICAL FIELD

This disclosure relates generally to virtual environment generation, and more particularly to system and method of providing an interactive user experience in a virtual industry premises.

### BACKGROUND

Industries have long relied on traditional operational methods, characterized by manual labor, machinery, and minimal integration of digital technologies. These traditional operational methods have been effective in their own way, allowing industries to carry out tasks such as production, distribution, and quality control. However, with the rapid advancements in technology and the emergence of digitalization as a driving force in modern economies, the traditional operational methods are facing increasing pressure to evolve.

The traditional operational methods used by the industries face various challenges. In the traditional operational methods, digital technologies are sparingly utilized, primarily for basic automation and record-keeping purposes. Persistence of paper-based record-keeping systems within the industries poses challenges due to their inherent inflexibility, hindering adaptability to changing requirements. The traditional operational methods involve manual labor-intensive operations, where tasks are performed by people instead of machines. While some level of automation is present, but its application is typically restricted to tasks that include repetitive actions and standardized processes. This lack of comprehensive digitalization and automation hampers industries' ability to optimize processes, leading to suboptimal efficiency and productivity levels.

Moreover, the traditional operational methods are predominantly characterized by on-premises operations, with limited remote work and digital collaboration opportunities. This lack of flexibility and adaptability can pose significant challenges, particularly in situations requiring rapid response or adjustment, such as during global crises or unexpected disruptions. Additionally, traditional prototyping methods and in-person inspections prove to be time-consuming and costly, slowing down product development processes. Additionally, many industries still focus on mass production, offering limited customization options for products and services. The traditional operational methods may result in missed opportunities to meet individual customer preferences and capitalize on specialized markets. Furthermore, fixed workflows and traditional supply chains impede agility and responsiveness to changing market dynamics.

The present invention is directed to overcome one or more limitations stated above or any other limitations associated with the known arts.

### SUMMARY

In one embodiment, a method for providing an interactive user experience in a virtual industry premises is disclosed. In one example, the method may include receiving information associated with a plurality of physical assets within a physical industry premises. The method may include creating the virtual industry premises corresponding to the physical industry premises based on the information, using a digital twin technology and an Artificial Intelligence (AI) model. The virtual industry premises may include a plurality of Three-Dimensional (3D) virtual replicas of the plurality of physical assets. Further, creating the virtual industry premises may include dynamically receiving data corresponding to the plurality of physical assets, and updating the virtual industry premises based on the data. The method may further include initiating a user experience in the virtual industry premises based on a user role, upon a successful verification of user credentials received from the user.

In one embodiment, a system for providing an interactive user experience in a virtual industry premises is disclosed. In one example, the system may include a processor and a memory communicatively coupled to the processor. The memory may store processor-executable instructions, which, on execution, may cause the processor to receive information associated with a plurality of physical assets within a physical industry premises. The processor-executable instructions, on execution, may further cause the processor to create the virtual industry premises corresponding to the physical industry premises based on the information, using a digital twin technology and an Artificial Intelligence (AI) model. The virtual industry premises may include a plurality of Three-Dimensional (3D) virtual replicas of the plurality of physical assets. To create the virtual industry premises, the processor-executable instructions, on execution, may further cause the processor to dynamically receive data corresponding to the plurality of physical assets, and update the virtual industry premises based on the data The processor-executable instructions, on execution, may further cause the processor to initiate a user experience in the virtual industry premises based on a user role, upon a successful verification of user credentials received from the user.

In one embodiment, a non-transitory computer-readable medium storing computer-executable instructions for providing an interactive user experience in a virtual industry premises is disclosed. In one example, the stored instructions, when executed by a processor, may cause the processor to perform operations including receiving information associated with a plurality of physical assets within a physical industry premises. The operations may further include creating the virtual industry premises corresponding to the physical industry premises based on the information, using a digital twin technology and an Artificial Intelligence (AI) model. The virtual industry premises may include a plurality of Three-Dimensional (3D) virtual replicas of the plurality of physical assets. The operations may further include dynamically receiving data corresponding to the plurality of physical assets and updating the virtual industry premises based on the data, for creating the virtual industry premises. The operations may further include initiating a user experience in the virtual industry premises based on a user role, upon a successful verification of user credentials received from the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a functional block diagram of a system for providing an interactive user experience in a virtual industry premises, in accordance with some embodiments.

FIG. 2 illustrates a block diagram of a system for providing an interactive user experience in a virtual industry premises on various devices, in accordance with some embodiments of the present disclosure.

FIG. 3 illustrates a flow diagram of an exemplary process for providing an interactive user experience in a virtual industry premises, in accordance with some embodiments of the present disclosure.

FIGS. 4A-4B illustrate exemplary scenarios of providing an interactive user experience in a virtual multiuser plant, in accordance with some embodiments of the present disclosure.

FIG. 5 illustrates an exemplary scenario of providing an interactive user experience in a virtual warehouse, in accordance with some embodiments of the present disclosure.

FIG. 6 illustrates an exemplary scenario of providing an interactive user experience in a virtual multiuser training session, in accordance with some embodiments of the present disclosure.

FIG. 7 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

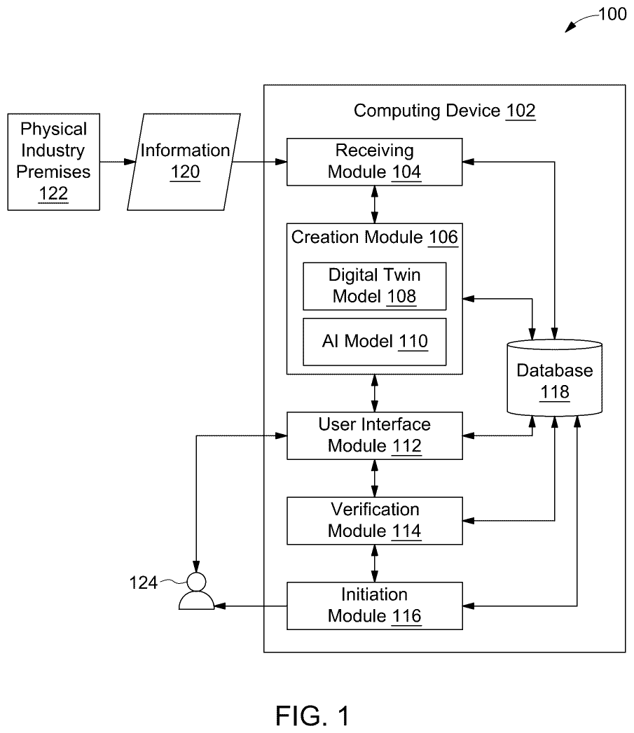

Referring now to FIG. 1, a functional block diagram of a system 100 for providing an interactive user experience in a virtual industry premises is illustrated, in accordance with some embodiments of the present disclosure. To provide the interactive user experience, the system 100 may include a computing device 102. Examples of the computing device 102 may include, but are not limited to, a desktop, a laptop, a notebook, a tablet, a smartphone, a mobile phone, a computing device, or the like.

The computing device 102 introduces a versatile Metaverse platform that accommodates multiple realms accessible through a variety of devices. The platform serves a dual purpose by creating virtual environments suitable for both consumer engagement and internal business processes within an organization. The platform enables end users to virtually experience products and services, enhancing engagement and understanding. Furthermore, the computing device 102 emphasizes integration of physical and virtual environments, enabling seamless human interaction, which is pivotal in bridging a gap between digital and physical worlds. The platform holds a potential to revolutionize how organizations engage with users and conduct business, fostering a dynamic and immersive digital ecosystem.

The computing device 102 may include a processor and a memory (not shown in FIG. 1). The memory may store instructions that, when executed by the processor, cause the processor to provide the interactive user experience. The memory may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.) The memory may include a receiving module 104, a creation module 106 including a digital twin model 108 and an Artificial Intelligence (AI) model 110, a user interface module 112, a verification module 114, and an initiation module 116. Also, the memory may include a database 118 to store various data and intermediate results generated by the modules 104-116.

The receiving module 104 may be configured to receive information 120 associated with a plurality of physical assets within a physical industry premises 122. Examples of the physical industry premises 122 may include, but are not limited to, a warehouse center, a manufacturing plant, a healthcare facility, an oil refinery, a steel mill, a chemical plant, a power plant, a food processing facility, an automotive assembly plant, a mining site, an aerospace manufacturing facility, a shopping facility, an event site, a training, and education center, and the like. Further, examples of the physical assets may include, but are not limited to, pallet racks, forklifts, conveyor systems, storage bins, packaging machinery, assembly lines, robotic arms, workstations, raw materials, inventory, heat exchangers, users, reactors, rolling mills, cranes, pumps, valves, turbines, refrigeration units, engine assembly lines, inspection station, aircraft components, shopping carts, display racks and shelves, stage equipment, banners, classroom furniture, computers, interactive boards, beds, examination tables, monitors, ventilators, patients, diagnostic tools, and the like. The information associated with the physical assets may include, but is not limited to, a Three-Dimensional (3D) model, a blueprint, a serial number, a tag, a barcode, specifications (e.g., make, model, manufacture, dimensions, capacity, and technical information), a location, maintained history, data related to current condition, operational status, operational parameters, a layout, Product Lifecycle Management (PLM) details, avatars, Building Information Modeling (BIM) data and the like. The receiving module 104 may be communicatively coupled to the creation module 106.

The creation module 106 may be configured to create the virtual industry premises corresponding to the physical industry premises 122 based on the information 120, using the digital twin model 108 leveraging the AI model 110. The digital twin model 108 uses a digital twin technology. The AI model 110 may be a single AI model or an ensemble model. Examples of the AI model 110 may include, but are not limited to, a Natural Language Processing (NLP) model, a computer vision model, a reinforcement learning model, a Generative Adversarial Network (GAN) model, and a recommendation model. In one embodiment, the AI model 110 may be a Generative AI (Gen-AI) model. The Gen-AI model interacts seamlessly across languages, retrieving vital information. The Gen AI model may access pertinent details from its knowledge repository, encompassing manuals, protocols, and standard operational guidelines. Additionally, the Gen AI-powered model is adept at addressing common queries, offering guidance on troubleshooting steps. The virtual industry premises may include a plurality of 3D virtual replicas of the plurality of physical assets. The information 120 serves as a foundation for generating detailed 3D models that accurately represent a layout and a structure of real-world industrial sites. The 3D models may be transformed into immersive visualizations, capturing intricate details, and ensuring realistic depiction. These visualizations may be optimized for compatibility with various Virtual Reality (VR) devices, enabling seamless viewing and interaction. To ensure that these visualizations may be viewed on different types of VR devices, a serialization algorithm may be used that converts the visualizations into a standard format or a unity-readable format. In some embodiments, the serializer algorithm may be used to generate byte data representing a 3D model. Further, animations from the 3D model may be extracted and applied to create an immersive and realistic experience. Through this iterative process of data collection, modeling, visualization, and optimization, the virtual industry premises that closely mirror physical counterparts may be created, facilitating applications such as simulation, analysis, and training in a digital environment.

In some embodiments, the creation module 106 may receive data corresponding to the plurality of physical assets dynamically. Further, the creation module 106 may update the virtual industry premises, in real-time, based on that data. For example, when a change in at least one physical asset of the plurality of physical assets is identified, the change may be reflected in a corresponding 3D virtual replica of the at least one physical asset, to update the virtual industry premises. The change may include one of a change in position of the at least one physical asset, a change in an attribute of the at least one physical asset, and a change in property of the at least one physical asset. The creation module 106 may be communicatively coupled to the user interface module 112.

The user interface module 112 may render a login page associated with the virtual industry premises to a user 124 via a display. The login page may include various field required to be filled by the user 124. Further, user interface module 112 may be configured for receiving user credentials from the user 124, in response to rendering the login page. The user credentials may include one of a username, an access code, biometric data, and the user role. The user 124 may enter the user credentials when the user 124 plans to access the virtual industry premises. Further, the user interface module 112 may be communicatively coupled to the verification module 114. The user interface module 112 may process the user credentials to the verification module 114.

The verification module 114 may be configured to verify the user credentials. A verification may be a successful verification or an unsuccessful verification. Their verification module 114 may match details provided by the user 124 (i.e. the user credentials) with stored data corresponding to the user 124 within the database 118. If the details successfully match the stored data, the verification may be the successful verification. Alternatively, when there is a mismatch in the details and the stored data, the verification may be the unsuccessful verification, and the user 124 may be asked to enter the correct details. The verification module 114 may be communicatively coupled to the initiation module 116.

The initiation module 116 may be configured to initiate a user experience in the virtual industry premises upon the successful verification of the user credentials. The user experience may include interaction with the plurality of physical assets, interaction with the AI model, and collaborative training. The interaction with the AI model may include at least one of detecting anomalies, providing recommendations, addressing issues, and determining challenges, based on historical data and an analytics technique. It should be noted that user experience may be initiated based on a user role. This means the user experience may vary depending on a user's role within that environment. By way of an example, a trainee may be granted access to a tailored learning environment within the virtual industry premises. This may include interactive training modules, simulations of real-world scenarios, and guided tutorials specific to their role or tasks. For example, a trainee working in a manufacturing setting may engage in virtual equipment operation exercises, safety training simulations, or troubleshooting scenarios designed to enhance their skills and knowledge.

By way of another example, when a manager's credentials are verified, they may access a different user experience tailored to their responsibilities and objectives. This may include functionalities geared towards overseeing operations, analyzing data, and making strategic decisions. For example, a manager in a production facility may have access to dashboards displaying real-time production metrics, tools for resource allocation and scheduling, as well as simulations for evaluating production optimization strategies. Additionally, the manager may have permission to review performance analytics and collaborate with other stakeholders within the environment.

In some embodiments, the computing device 102 may be configured to retrieve spatial data corresponding to the user 124. Further, a location of the user 124 within the physical industry premises and the virtual industry premises may be identified. The information pertinent to the location may be provided to the user via the user interface module 112. In some embodiments, a user's preferred language may be identified using the AI model 110. Further, responses may be adjusted based on the user's preferred language, which may be further rendered to the user 124 via the user interface module 112.

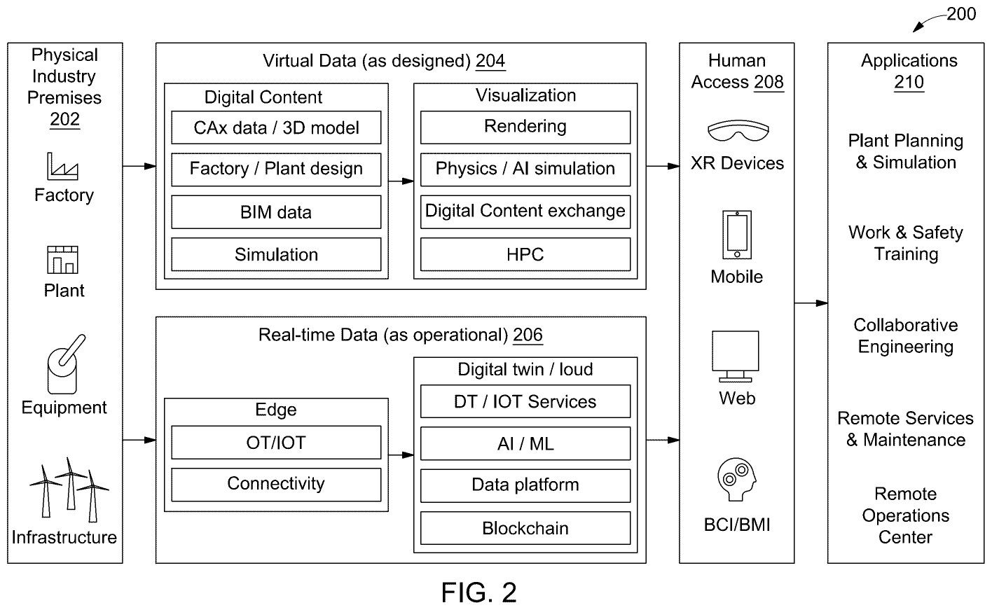

Referring now to FIG. 2, a block diagram of a system 200 for providing an interactive user experience in a virtual industry premises on various devices is illustrated, in accordance with some embodiments of the present disclosure. FIG. 2 is explained in conjunction with FIG. 1. The system 200 may include the computing device 102 to perform various functions. The system 200 may correspond to a platform built on a metaverse engine, designed to create different types of digital world known as realms. Within these realms, users may be capable of experiencing real physical elements represented as digital twins in virtual environments. Through this platform, the users may immerse themselves in the virtual environments that accurately replicate real-world settings, offering an interactive experience that blurs boundaries between physical and digital realms.

The platform offers pre-built, reusable features for teleportation, navigation, collaboration with other users, loading immersive experience applications, and integrating with digital twins and other enterprise systems. This enables virtual representation of physical world and interaction with digital objects of the virtual representation. The system 200 outlines an integration of an industrial metaverse VR application with a cloud infrastructure, a generative AI, and Internet of Things (IoT) components. The system 200 includes creation of an interactive and adaptive digital environment that enhances industrial processes and collaboration.

The system 200 may include a physical industry premises 202. Examples of the physical industry premises 202 may include a factory, a plant an equipment, and an infrastructure. Data corresponding to the physical industry premises 202 may be processed to create the virtual industry premises. The system 200 may gather virtual data 204 while creating the virtual industry premises 202. The virtual data 204 may include digital content including Computer Aided (x) (CAx) data such as Computer Aided Design (CAD) data, Computer Aided Manufacturing (CAM) data, and the like, or 3D models. The digital content may further include a factory/plant design, BIM data, and simulation. Further, visualization may be produced using the digital content. The visualization may leverage rendering, physics/AI simulation, digital content exchange, and High-Performance Computing (HPC). The system 200 may gather real-time data 206 or operational data from edge through Operational Technology (OT)/IoT and connectivity.

The system 200 uses technology platforms like IoT/OT and IT integration, digital twin technology/cloud enhanced with DT/IoT services, data platforms, AI models and blockchain, and virtual world engines, featuring remote rendering and spatial computing. These components collectively enable seamless fusion of physical and digital worlds. The IoT/OT integration connects real-world assets and data to IT systems, providing real-time insights for decision-making. The digital twin technology leverages the AI/Machine Learning (ML) models to create dynamic and accurate virtual representations of physical assets, while blockchain ensures data integrity and transparency. The virtual world engines deliver immersive experiences, enabling remote rendering and spatial computing for collaborative work.

The system 200 leverages content, including Product Lifecycle Management (PLM), plant layout, 3D models, CAD data, animation and rendering technologies, APIs, Extended Reality Software Development Kits (XR SDKs), avatars, and user authentication. This helps creating an immersive and collaborative digital environment. Further, this enables the users to interact with accurate representations of the physical assets and environments, fostering real-time decision-making, data visualization, and seamless integration through Application Programming Interfaces (API) s and XR SDKs. It should be noted that avatars may serve as representations of users within the virtual environment, enabling seamless communication and collaboration. They play a crucial role in maintaining secure access control and ensuring data privacy through user authentication mechanisms. By representing the users in the virtual space, avatars facilitate interaction while safeguarding sensitive information and controlling access to resources.

The system 200 uses components including cloud resources such as HPC and scalable storage, which enable processing of vast datasets and storage of digital twin information. Further, cloud platform services provide a flexible environment for hosting metaverse applications and ensuring accessibility and integration. The system 200 provides robust cybersecurity measures that are essential for safeguarding data and assets digital ecosystem, protecting against cyber threats and breaches. The system 200 includes network communication, spanning wired, wireless, and 5G technologies. This robust network forms a critical foundation for real-time data exchange and collaboration within the platform, providing high-speed connectivity, low latency, and seamless communication capabilities. These components collectively empower the system 200, enabling dynamic decision-making, secure operations, and immersive experiences that bridge the physical and digital realms.

The system 200 may provide a human access 208 to the virtual industry premises. The system 200 provides a capability to render the virtual industry premises on various devices including, but not limited to, Extended Reality (XR) devices, a mobile, a web, a Brain-Computer Interface (BCI), and a Brain-Machine Interface (BMI). It should be noted that to ensure that the visualizations may be viewed on different types of Virtual Reality (VR) devices, the visualizations may be converted to a standard format. The system 200 may have utility in various applications 210 including, but not limited to, plant planning and simulation, work and safety training, collaborative engineering, remote services and maintenance, and remote operation centers.

It should be noted that all such aforementioned modules 104-116 may be represented as a single module or a combination of different modules. Further, as will be appreciated by those skilled in the art, each of the modules 104-116 may reside, in whole or in parts, on one device or multiple devices in communication with each other. In some embodiments, each of the modules 104-116 may be implemented as dedicated hardware circuit comprising custom application-specific integrated circuit (ASIC) or gate arrays, off-the-shelf semiconductors such as logic chips, transistors, or other discrete components. Each of the modules 104-116 may also be implemented in a programmable hardware device such as a field programmable gate array (FPGA), programmable array logic, programmable logic device, and so forth. Alternatively, each of the modules 104-116 may be implemented in software for execution by various types of processors. An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module.

As will be appreciated by one skilled in the art, a variety of processes may be employed for providing the interactive user experience in the virtual industry premises. For example, the computing device 102 may provide the interactive user experience by the processes discussed herein. In particular, as will be appreciated by those of ordinary skill in the art, control logic and/or automated routines for performing the techniques and steps described herein may be implemented by the computing device 102 either by hardware, software, or combinations of hardware and software. For example, suitable code may be accessed and executed by the one or more processors on the computing device 102 to perform some or all of the techniques described herein. Similarly, application specific integrated circuits (ASICs) configured to perform some or all of the processes described herein may be included in the one or more processors on the computing device 102.

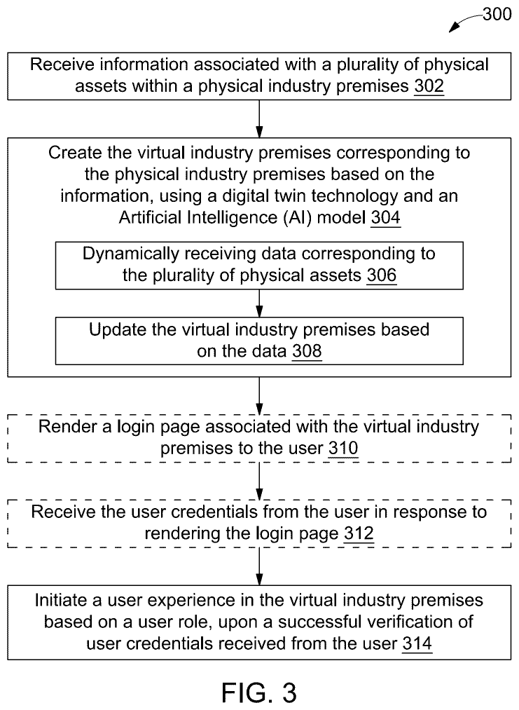

Referring now to FIG. 3, an exemplary process 300 for providing an interactive user experience in a virtual industry premises is depicted via a flowchart, in accordance with some embodiments of the present disclosure. FIG. 3 is explained in conjunction with FIGS. 1-2. Each step of the process 300 may be implemented by a computing device (such as the computing device 102).

At step 302, information associated with a plurality of physical assets may be received using a receiving module (same as the receiving module 104). The plurality of physical assets may be within a physical industry premises (such as the physical industry premises 122). Examples of the physical industry premises 122 may include, but are not limited to, a warehouse center, a manufacturing plant, a healthcare facility, an oil refinery, a steel mill, a chemical plant, a power plant, a food processing facility, an automotive assembly plant, a mining site, an aerospace manufacturing facility, a shopping facility, an event site, a training, and education center, and the like. Further, examples of the physical assets may include, but are not limited to, pallet racks, forklifts, conveyor systems, storage bins, packaging machinery, assembly lines, robotic arms, workstations, raw materials, inventory, heat exchangers, users, reactors, rolling mills, cranes, pumps, valves, turbines, refrigeration units, engine assembly lines, inspection station, aircraft components, shopping carts, display racks and shelves, stage equipment, banners, classroom furniture, computers, interactive boards, beds, examination tables, monitors, ventilators, patients, diagnostic tools, and the like. The information associated with the physical assets may include, but is not limited to, a Three-Dimensional (3D) model, a blueprint, a serial number, a tag, a barcode, specifications (e.g., make, model, manufacture, dimensions, capacity, and technical information), a location, maintained history, data related to current condition, operational status, operational parameters, a layout, Product Lifecycle Management (PLM) details, avatars, Building Information Modeling (BIM) data and the like.

Thereafter, at step 304, the virtual industry premises may be created using a creation module (such as the creation module 106). It should be noted that the information received may be considered for creating the virtual industry premises. Further, a digital twin technology and an Artificial Intelligence (AI) model (same as the AI model 110) may be used to create the virtual industry premises. The AI model 110 may be a single AI model or an ensemble model. Examples of the AI model may include, but are not limited to, a Natural Language Processing (NLP) model, a computer vision model, a reinforcement learning model, a Generative Adversarial Network (GAN) model, and a recommendation model. The virtual industry premises may include a plurality of Three-Dimensional (3D) virtual replicas of the plurality of physical assets.

At step 306, data corresponding to the plurality of physical assets may be received dynamically using the receiving module. Further, at step 308, the virtual industry premises may be updated by the creation module based on the data received in real-time. In some embodiments, a change in at least one physical asset of the plurality of physical assets may be identified based on the data. Further, in some embodiments, the change may be reflected in a corresponding 3D virtual replica of the at least one physical asset. The change may include, but is not limited to, at least one of a change in position of the at least one physical asset, a change in an attribute of the at least one physical asset, and a change in property of the at least one physical asset.

At step 310, a login page associated with the virtual industry premises may be rendered to a user (same as the user 124) via a user interface module (such as the user interface module 112). The login page may include various field required to be filled by the user. At step 312, the user credentials may be received from the user in response to rendering the login page via the user interface module. The user credentials may include one of a username, an access code, biometric data, and the user role. The user may enter the user credentials when the user plans to access the virtual industry premises.

At step 314, a user experience in the virtual industry premises may be initiated using an initiation module (same as the initiation module 116). The user experience may be initiated based on a user role and upon a successful verification of user credentials received from the user. In some embodiments, the user credentials may be verified through a verification module (such as the verification module 114). A verification may be the successful verification or an unsuccessful verification. Details provided by the user (i.e. the user credentials) may be matched with stored data corresponding to the user. If the details successfully match the stored data, the verification may be the successful verification. Alternatively, when there is a mismatch in the details and the stored data, the verification may be the unsuccessful verification, and the user may be asked to enter the correct details. The user experience may include interaction with the plurality of physical assets, interaction with the AI model, and collaborative training. It may be noted that the interaction with the AI model further may include, but is not limited to, detecting anomalies, providing recommendations, addressing issues, and determining challenges, based on historical data and an analytics technique.

By way of an example, consider a user experience within a smart factory environment where workers interact with various physical assets, collaborate with colleagues during training sessions, and engage with an AI model. A technician may be conducting routine maintenance on a production line. During this process, the technician may interact with the AI model, which continuously analyzes historical data and employs analytics techniques to detect anomalies in equipment behavior. If the AI model detects a potential issue, it provides real-time recommendations to the technician, guiding them through troubleshooting steps to address problems efficiently. Additionally, the AI model identifies recurring challenges faced by operators and suggests proactive measures to mitigate future issues, enhancing operational efficiency and minimizing downtime.

The user experience may be initiated based on the user role. This means the user experience may vary depending on a user's role within that environment. By way of an example, a trainee may be granted access to a tailored learning environment within the virtual industry premises. This may include interactive training modules, simulations of real-world scenarios, and guided tutorials specific to their role or tasks. For example, a trainee working in a manufacturing setting may engage in virtual equipment operation exercises, safety training simulations, or troubleshooting scenarios designed to enhance their skills and knowledge.

By way of another example, when a manager's credentials are verified, they may access a different user experience tailored to their responsibilities and objectives. This may include functionalities geared towards overseeing operations, analyzing data, and making strategic decisions. For example, a manager in a production facility may have access to dashboards displaying real-time production metrics, tools for resource allocation and scheduling, as well as simulations for evaluating production optimization strategies. Additionally, the manager may have permission to review performance analytics and collaborate with other stakeholders within the environment.

In some embodiments, spatial data corresponding to the user may be retrieved upon successful verification of user credentials received from the user. Further, a location of the user within the physical industry premises and the virtual industry premises may be identified based on the spatial data. Thereafter, information pertinent to the location may be provided to the user. By way of an example, in case of a power plant management system, consider that an engineer logs in with user credentials to access plant's virtual monitoring and control interface. Upon successful verification, the spatial data corresponding to the engineer may be retrieved. The spatial data may include a location of the engineer within the power plant and a virtual position of the engineer within a digital representation of the power plant. For example, the engineer is stationed near a specific turbine within the power plant. This location may be identified, and the engineer may be provided with pertinent information about the turbine's performance, maintenance schedule, or any relevant operational updates.

In some embodiments, a user's preferred language may be identified via the AI model. Further, responses may be adjusted based on the user's preferred language. For example, in a domain of collaborative training platforms, consider a scenario where professionals from different countries may be engaged in a virtual training session. As professionals join this platform, the AI model may dynamically identify each professional's preferred language through their communication patterns. If one participant primarily communicates in “English” while another prefers “French”, the AI model may recognize these preferences. Consequently, responses and instructional materials may be adjusted to accommodate diverse linguistic needs of the professionals. This means providing training materials, prompts, and instructions in the preferred language of each professional, fostering effective collaboration and comprehension among the participants regardless of their linguistic backgrounds. Such adaptability ensures that collaborative training sessions are inclusive, engaging, and conducive to learning across cultural and linguistic boundaries.

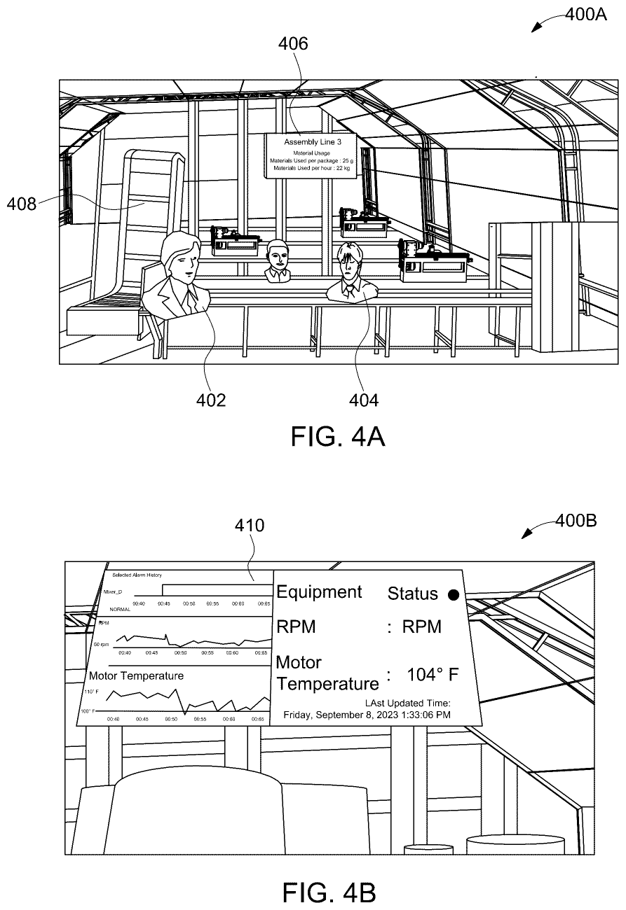

Referring now to FIGS. 4A-4B, exemplary scenarios 400A and 400B of providing an interactive user experience in a virtual multiuser plant is illustrated, in accordance with some embodiments of the present disclosure. FIGS. 4A-4B are explained in conjunction with FIGS. 1-3.

As illustrated in FIG. 4A, the exemplary scenario 400A includes a third assembly line of the virtual multiuser plant. The virtual multiuser plant is a digital representation that simulates real-world manufacturing facilities. The virtual multiuser plant includes 3D replicas of various physical assets. There are avatars representing personnel involved in plant operations. For example, avatars 402 and 404 are shown corresponding to different roles within the plant. The avatar 402 represents a Quality Check (QC) inspector, responsible for ensuring product quality, while the avatar 404 represents an engineer, likely tasked with maintenance or optimization of equipment. Further, the virtual multiuser plant may include a display 406 rendering details pertinent to the third assembly line. For example, the display 406 provides information related to material usage on the third assembly line including metrices such as material used per package (25 g), material used per hour (22 kg). Such information is essential for monitoring production efficiency and resource allocation within the plant. Further, the virtual multiuser plant may also include 3D virtual replicas corresponding to various equipment, such as a digital twin 408.

Referring now to FIG. 4B, the exemplary scenario 400B includes display 410 rendering details corresponding to an equipment. The details may include metrices such as a status, a speed, a motor temperature (104° F.), last updated time, and graphs corresponding to the metrices.

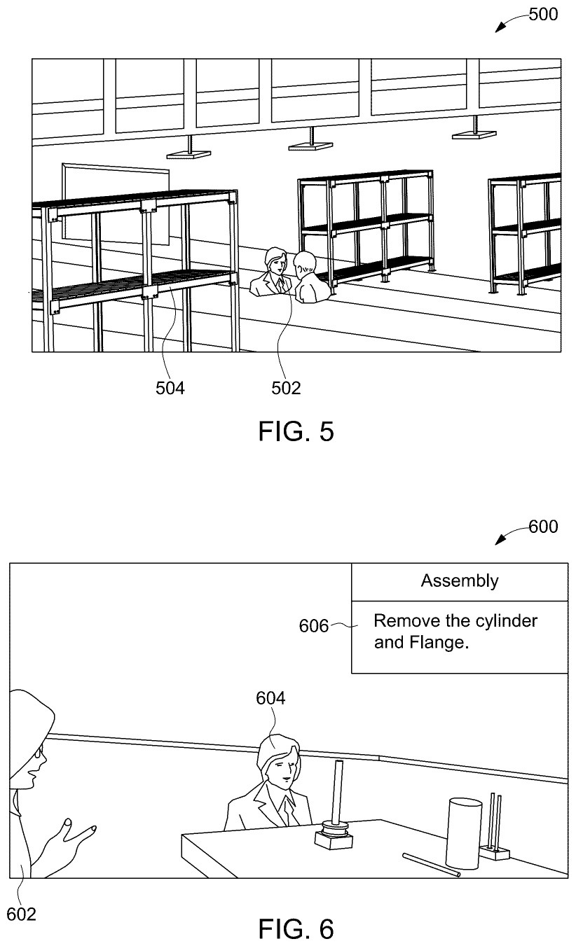

Referring now to FIG. 5, an exemplary scenario 500 of providing an interactive user experience in a virtual warehouse is illustrated, in accordance with some embodiments of the present disclosure. FIG. 5 is explained in conjunction with FIGS. 1-4A-4B. This virtual warehouse serves as a digital representation of a physical warehouse or a storage facility, offering a dynamic environment where users may engage with various functionalities and assets. The virtual warehouse includes avatars representing various users. For example, an avatar 502 is illustrated corresponding to a senior engineer. The avatar 502 may be interacting with another avatar. These avatars serve as digital proxies for real-world personnel, enabling the users to navigate and interact within the virtual warehouse, mimicking their roles and responsibilities within warehouse setting. Further, the virtual warehouse includes 3D replicas corresponding to various racks or shelving units found in the physical warehouse, for example a virtual replica 504. These 3D replicas mirror a layout and structure of real-world storage infrastructure, allowing the users to visualize and interact with inventory items, track their locations, and manage storage space efficiently.

By way of an example, consider a situation where the senior engineer, represented by the avatar 502, needs to conduct a routine inspection of inventory levels and organization within the warehouse. Using the avatar 502, the senior engineer navigates through the virtual space, accessing different sections of the warehouse and examining the virtual replicas of racks and shelves. The senior engineer may be able to zoom in on specific areas, inspect individual items, and update inventory records as needed. During the inspection, the senior engineer notices discrepancies in placement of certain items, indicating a potential error in inventory management. Further, using the interactive features of the virtual warehouse, the senior engineer may communicate with other warehouse personnel represented by their respective avatars, or interact with the AI model, to address the issue collaboratively.

Referring now to FIG. 6, an exemplary scenario 600 providing an interactive user experience in a virtual multiuser training session is illustrated, in accordance with some embodiments of the disclosure. FIG. 6 is explained in conjunction with FIGS. 1-5. In FIG. 6, a depiction of the virtual multiuser training session, representing immersive learning environment where avatars corresponding to various users engaged in collaborative training activities is presented. This virtual training session serves as a powerful tool for knowledge transfer and skill development, particularly in industrial or technical fields where hands-on training is required. For example, an avatar 602 represents an engineer, likely an experienced professional responsible for imparting knowledge and guiding trainees through operational procedures. An avatar 604 represents a trainee, an individual seeking to acquire new skills or enhance existing ones under the guidance of the engineer. The engineer may provide a step by step instructions to the trainee for performing an operation. Text corresponding to the instructions provided by the engineer may be displayed on a display 606, for example “Remove the cylinder and flange”. For brevity, some exemplary scenarios are explained in the disclosure, however, the disclosure has utility across various other domains.

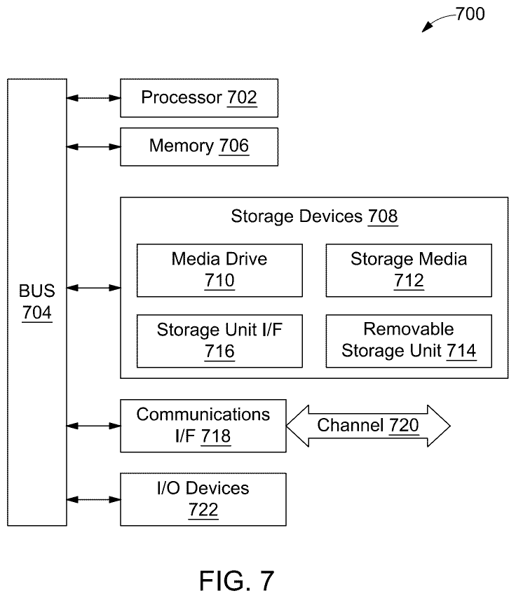

The disclosed methods and systems may be implemented on a conventional or a general-purpose computer system, such as a personal computer (PC) or server computer. Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller or other control logic. In this example, the processor 702 is connected to a bus 704 or other communication medium. In some embodiments, the processor 702 may be an Artificial Intelligence (AI) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during execution of instructions to be executed by the processor 702. The computing system 700 may likewise include a read only memory (“ROM”) or other static storage device coupled to bus 704 for storing static information and instructions for the processor 702.

The computing system 700 may also include a storage devices 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 712 may include, for example, a hard disk, magnetic tape, flash drive, or other fixed or removable medium that is read by and written to by the media drive 710. As these examples illustrate, the storage media 712 may include a computer-readable storage medium having stored therein particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 518. The communications interface 718 may be used to allow software and data to be transferred between the computing system 700 and external devices. Examples of the communications interface 718 may include a network interface (such as an Ethernet or other NIC card), a communications port (such as for example, a USB port, a micro USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via a channel 720. The channel 720 may carry signals and may be implemented using a wireless medium, wire or cable, fiber optics, or other communications medium. Some examples of the channel 720 may include a phone line, a cellular phone link, an RF link, a Bluetooth link, a network interface, a local or wide area network, and other communications channels.

The computing system 700 may further include Input/Output (I/O) devices 722. Examples may include, but are not limited to a display, keypad, microphone, audio speakers, vibrating motor, LED lights, etc. The I/O devices 722 may receive input from a user and also display an output of the computation performed by the processor 702. In this document, the terms “computer program product” and “computer-readable medium” may be used generally to refer to media such as, for example, the memory 706, the storage devices 708, the removable storage unit 714, or signal(s) on the channel 720 These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

The disclosure offers various advantages that resonate across different industries, causing significant transformations in how they operate, enabling remote work, real-time data analysis, digital twins, customization, resource efficiency, and sustainability. The disclosure enhances productivity and safety, reduces costs, and fosters improved customer experiences. The disclosure uses global collaboration, data-driven decision-making, quality control, and accessibility, all while contributing to reduced environmental impact and shaping the future of work and industry. The disclosure provides advantages spanning various domains including plant planning and simulation, where enterprises and manufacturers can harness immersive 3D visualization and simulation capabilities. By integrating IoT data and promoting collaboration among employees, businesses can optimize plant operations and enhance decision-making processes. Furthermore, the disclosure revolutionizes training and education by offering immersive experiences without a need for extensive physical infrastructure. This innovation democratizes access to academic and professional training, empowering learners to engage deeply with content from anywhere. The disclosure may have utility in virtual events that are increasingly popular in recent years, offering more integrated experiences, fostering engagement and interaction across diverse audiences. Additionally, retailers can leverage the disclosure to provide immersive shopping experiences, mimicking in-store environments without requiring shoppers' physical presence. Moreover, enterprises can foster better communication and collaboration among employees through augmented and virtual workspaces, enhancing productivity and innovation. In the realm of social media, the disclosure facilitates a transition to the metaverse, where users interact via 3D avatars, enriching social experiences beyond traditional text, photos, videos, or audio. Through these multifaceted applications, the disclosure shapes the future of work, education, retail, and social interaction, conducting in a new era of immersive experiences and collaboration.

The disclosure provides features like real-time data analysis that helps businesses experience heightened productivity and efficiency. Additionally, the disclosure makes remote work and collaboration easier, promoting a more flexible workforce by removing geographical barriers. The disclosure provides integration of digital twins and IoT that facilitates real-time monitoring and predictive maintenance, leading to reduced downtime and costs. Moreover, the disclosure provides customization and AI-driven resource optimization that enhance customer experiences while supporting sustainability goals. Streamlined operations and data-driven insights further contribute to cost savings and informed decision-making. Safety is also prioritized using autonomous systems in high-risk environments.

Furthermore, the disclosure brings specific advantages such as increased productivity through workforce assistance and self-guidance, reduced training time with immersive XR training modules, and savings on design and production costs by improving engineering workflows and minimizing physical prototypes. Additionally, it contributes to a lower carbon footprint by reducing travel and waste. Safety is improved through simulated environments for training and practice, preventing accidents and injuries. Collaboration is enhanced with modern collaborative tools, fostering a new way of learning, and working together.

The disclosure revolutionizes work practices by integrating digital technologies, connectivity, and data-driven strategies. It boosts efficiency, flexibility, and innovation. By seamlessly blending physical and digital realms, the disclosure reshapes the way work gets done. Through real-time data collection and analytics, the disclosure empowers industries with insights for quick and informed decision-making, enhancing process optimization and resource allocation. Additionally, it facilitates remote work and digital collaboration, enabling teams to operate from anywhere and fostering flexibility and adaptability. Moreover, the disclosure supports digital twin integration, allowing for virtual replicas of physical assets, which aid in real-time monitoring and predictive analysis, improving maintenance and asset management. It also enables customization and personalization of products and services based on customer preferences, driving efficiency and customer satisfaction. Sustainability is further promoted through AI-driven resource optimization, aligning with global environmental goals.

The disclosure prioritizes data security and real-time connectivity by enabling the blockchain technology, utilizing a mix of wired, wireless, and 5G technologies for a seamless experience. The disclosure allows for efficient loading and rendering of intricate 3D CAD models, as digital 3D content streaming incorporated. The disclosure facilitates immediate loading of varied environments, including factory layouts, manufacturing facilities, construction zones, and oil refineries, thereby boosting its adaptability. The disclosure employs visualization tools designed specifically for the industrial metaverse, enabling to produce charts, graphs, and immersive visuals to clarify complex data collections. The disclosure uses Generative AI (Gen-AI) technology, thereby facilitating real-time 3D asset generation. Using the Gen-AI technology, the interfaces and content may be tailored based on user roles, enhancing engagement. The disclosure provides compatibility with a range of devices such as Virtual Reality (VR) headsets, Augmented Reality (AR) glasses, desktop, computers, and mobile devices.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for providing an interactive user experience in a virtual industry premises. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of providing an interactive user experience in a virtual industry premises, the method comprising:
receiving, by a computing device, information associated with a plurality of physical assets within a physical industry premises;
creating, by the computing device, the virtual industry premises corresponding to the physical industry premises based on the information, using a digital twin technology and an Artificial Intelligence (AI) model, wherein the virtual industry premises comprises a plurality of Three-Dimensional (3D) virtual replicas of the plurality of physical assets, and wherein creating the virtual industry premises comprises:
dynamically receiving data corresponding to the plurality of physical assets; and
updating the virtual industry premises based on the data; and
initiating, by the computing device, a user experience in the virtual industry premises based on a user role, upon a successful verification of user credentials received from the user.

2. The method of claim 1, wherein initiating the user experience comprises:
rendering a login page associated with the virtual industry premises to the user; and
receiving the user credentials from the user in response to rendering the login page.

3. The method of claim 1, wherein updating the virtual industry premises:
identifying a change in at least one physical asset of the plurality of physical assets based on the data; and
reflecting the change in a corresponding 3D virtual replica of the at least one physical asset.

4. The method of claim 3, wherein the change comprises at least one of a change in position of the at least one physical asset, a change in an attribute of the at least one physical asset, and a change in property of the at least one physical asset.

5. The method of claim 1, wherein the user experience comprises interaction with the plurality of physical assets, interaction with the AI model, and collaborative training.

6. The method of claim 5, wherein interaction with the AI model further comprises at least one of detecting anomalies, providing recommendations, addressing issues, and determining challenges, based on historical data and an analytics technique.

7. The method of claim 1, wherein the user credentials comprise at least one of a username, an access code, biometric data, and the user role.

8. The method of claim 1, further comprising:
retrieving spatial data corresponding to the user;
identifying a location of the user within the physical industry premises and the virtual industry premises; and
providing information pertinent to the location to the user.

9. The method of claim 1, further comprising:
identifying a user's preferred language via the AI model; and
adjusting responses based on the user's preferred language.

10. A system for providing an interactive user experience in a virtual industry premises, the system comprising:
a processor; and
a memory communicatively coupled to the processor, wherein the memory stores processor instructions, which when executed by the processor, cause the processor to:
receive information associated with a plurality of physical assets within a physical industry premises;
create the virtual industry premises corresponding to the physical industry premises based on the information, using a digital twin technology and an Artificial Intelligence (AI) model, wherein the virtual industry premises comprises a plurality of Three-Dimensional (3D) virtual replicas of the plurality of physical assets, and wherein creating the virtual industry premises comprises:
dynamically receiving data corresponding to the plurality of physical assets; and
updating the virtual industry premises based on the data; and
initiate a user experience in the virtual industry premises based on a user role, upon a successful verification of user credentials received from the user.

11. The system of claim 10, wherein the processor-executable instructions cause the processor to initiate the user experience by:
rendering a login page associated with the virtual industry premises to the user; and
receiving the user credentials from the user in response to rendering the login page.

12. The system of claim 10, wherein the processor-executable instructions cause the processor to update the virtual industry premises by:
identifying a change in at least one physical asset of the plurality of physical assets based on the data; and
reflecting the change in a corresponding 3D virtual replica of the at least one physical asset.

13. The system of claim 12, wherein the change comprises at least one of a change in position of the at least one physical asset, a change in an attribute of the at least one physical asset, and a change in property of the at least one physical asset.

14. The system of claim 10, wherein the user experience comprises interaction with the plurality of physical assets, interaction with the AI model, and collaborative training.

15. The system of claim 14, wherein interaction with the AI model further comprises at least one of detecting anomalies, providing recommendations, addressing issues, and determining challenges, based on historical data and an analytics technique.

16. The system of claim 10, wherein the user credentials comprise at least one of a username, an access code, biometric data, and the user role.

17. The system of claim 10, wherein the processor-executable instructions further cause the processor to:
retrieve spatial data corresponding to the user;
identify a location of the user within the physical industry premises and the virtual industry premises; and
provide information pertinent to the location to the user.

18. The system of claim 10, wherein the processor-executable instructions further cause the processor to:
identify a user's preferred language via the AI model; and
adjust responses based on the user's preferred language.

19. A non-transitory computer-readable medium storing computer-executable instructions for providing an interactive user experience in a virtual industry premises, the computer-executable instructions configured for:
receiving information associated with a plurality of physical assets within a physical industry premises;
creating the virtual industry premises corresponding to the physical industry premises based on the information, using a digital twin technology and an Artificial Intelligence (AI) model, wherein the virtual industry premises comprises a plurality of Three-Dimensional (3D) virtual replicas of the plurality of physical assets, and wherein creating the virtual industry premises comprises:
dynamically receiving data corresponding to the plurality of physical assets; and
updating the virtual industry premises based on the data; and
initiating a user experience in the virtual industry premises based on a user role, upon a successful verification of user credentials received from the user.

20. The non-transitory computer-readable medium of claim 19, wherein the computer-executable instructions further configured for:
rendering a login page associated with the virtual industry premises to the user; and
receiving the user credentials from the user in response to rendering the login page.
